(19) United States
(12) Patent Application Publication
(10) Pub. No.: US 2016/0005060 A1
(43) Pub. Date: Jan. 7, 2016

(54) METHOD AND SYSTEM FOR PREDICTING SPENDING ON TRAVEL

(71) Applicant: MasterCard International Incorporated, Purchase, NY (US)

(72) Inventor: Andrew A. ROBINSON, Bessacarr (GB)

(73) Assignee: MasterCard International Incorporated, Purchase, NY (US)

(21) Appl. No.: 14/321,128

(22) Filed: Jul. 1, 2014

(51) Int. Cl. G06Q 30/02; G06F 17/30

(52) U.S. Cl. CPC G06Q 30/0205; G06F 17/30241; G06F 17/30873; G06F 17/30598

(57) ABSTRACT

A system for analyzing spending data includes a database, a receiving device and a processing device. The database stores a geographic area associated with a primary purchase area of a consumer. The receiving device receives transaction data for payment transactions for a plurality of consumers, wherein the transaction data includes purchase data, a transaction location, and a transaction time and/or date associated with the payment transaction. The processing device identifies the transaction data of the plurality of payment transactions originating at a location outside the primary purchase geographic area; generates a filtered set of payment transactions based on the identified transaction data; analyzes spending behaviors of the plurality of consumers; generates an aggregated report of transaction data occurring within a predetermined period of time for the plurality of consumers; and categorizes, for each consumer, the consumer's relative placement within the aggregated report based on a plurality of purchase attributes included.

### FIELD

The present disclosure relates to technology facilitating the analysis of spending data, particularly foreign spending.

### BACKGROUND

In modern times, advertisers and merchants may often desire to market directly to consumers with the highest possible conversion rate in an effort to both increase revenue and decrease expenses. With the increase in travel and travel-related expenses by consumers, merchants, retailers, offer providers, and other entities have an increased desire to advertise, distribute offers, or otherwise push content to the consumers based on the consumers' particular spending behavior. However, the many merchants, retailers, offer providers, and other entities tend to have limited information about the consumers. Conventional methods for distributing content to the consumers include distributing offers or advertisements to all consumers, without regard for the preferences of the consumer or whether the consumer is likely to travel, which may result in a low success rate.

Consumers may also be less likely to sort through the offers or advertisements to find the ones relevant to their particular interest when they receive multiple offers or advertisements from merchants unrelated to their current travel plans.

However, obtaining additional meaningful insights into the spending behavior of consumers is technologically challenging, particularly on a commercial scale, particularly within a given segment of the market, such as travel related expenses. Particularly, this presents a technical problem of how to gather and analyze the information.

Therefore, there is a need to develop technical solutions for gaining additional insights into the spending behavior of the consumers when transactions related to travel-related expenses are conducted and/or use this insight to target advertisements and offers to generate increased sales.

### SUMMARY

The present disclosure provides a description of a system and method for analysis of spending behavior to promote foreign spending that provides a technical solution not found in the prior art.

A method for identifying purchase transaction data for promoting foreign spending, includes: storing, in a database, a geographic area associated with a primary purchase area of each of a plurality of consumers; receiving, by a receiving device, transaction data for a plurality of payment transactions for each of the plurality of consumers, wherein the transaction data includes at least purchase data, a transaction location, and a transaction time and/or date associated with the payment transaction; identifying, by a processing device, at least the transaction data of the plurality of payment transactions originating at a location outside the primary purchase geographic area associated with the consumer based on the transaction location included in the received transaction data; generating, by the processing device, a filtered set of payment transactions based on the identified transaction data; analyzing, for each of the payment transactions in the filtered set of payment transactions, spending behaviors based on the transaction data involving the plurality of consumers; associating, in the database, the analyzed spending behaviors with the primary purchase geographic area associated with each of the plurality of consumers; generating, by the processing device, an aggregated report of transaction data among the filtered set of payment transactions occurring within a predetermined period of time for the plurality of consumers; and categorizing, for each of the plurality of consumers, the consumer's relative placement within the aggregated report based on a plurality of purchase attributes included in the filtered set of payment transactions.

A system for identifying purchase transaction data for promoting foreign spending, includes: a database storing a geographic area associated with a primary purchase area of each of a plurality of consumers; a receiving device configured to receive transaction data for a plurality of payment transactions for each of the plurality of consumers, wherein the transaction data includes at least purchase data, a transaction location, and a transaction time and/or date associated with the payment transaction; and a processing device.

The processing device is configured to: identify at least the transaction data of the plurality of payment transactions originating at a location outside the primary purchase geographic area associated with the consumer based on the transaction location included in the received transaction data; generate a filtered set of payment transactions based on the identified transaction data; analyze, for each of the payment transactions in the filtered set of payment transactions, spending behaviors based on the transaction data involving the plurality of consumers; associate, in the database, the analyzed spending behaviors with the primary purchase geographic area associated with each of the plurality of consumers; generate an aggregated report of transaction data among the filtered set of payment transactions occurring within a predetermined period of time for the plurality of consumers; and categorize, for each consumer, the consumer's relative placement within the aggregated report based on a plurality of purchase attributes included in the filtered set of payment transactions.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A, 1B, 1C are a high level architecture, data flow diagrams illustrating a system for the analysis of transaction data to determine travel-related spending in accordance with exemplary embodiments.

FIG. 2 is a block diagram illustrating the processing server of FIGS. 1A, 1B, and 1C for the analysis of transaction data in accordance with exemplary embodiments.

FIG. 3 is a flow chart illustrating a method for analyzing transaction data to determine travel-related spending in accordance with exemplary embodiments.

FIG. 4 is block diagram illustrating the transaction database of FIGS. 1A, 1B, and 1C in accordance with exemplary embodiments.

FIG. 5 is a flow chart illustrating a method for analyzing transaction data to determine travel-related spending in accordance with exemplary embodiments.

FIG. 6 is a chart illustrating the analysis results in accordance with exemplary embodiments.

FIG. 7 is another chart illustrating the analysis results based on the season of travel in accordance with exemplary embodiments.

FIG. 8 is a graph illustrating the analysis results based on method of payment in accordance with exemplary embodiments.

FIG. 9 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Merchant—An entity that provides products (e.g., goods and/or services) for purchase by another entity, such as a consumer or another merchant. A merchant may be a consumer, a retailer, a wholesaler, a manufacturer, individual, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant, and may be someone otherwise not in a related business, such as a purchaser in a person to person exchange.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, debit account, virtual payment account, etc. A payment account may be associated with an entity, which may include a person, family, company, corporation, governmental entity, etc. In some instances, a payment account may be virtual, such as those accounts operated by PayPal®, etc.

Transaction Account—A card or data associated with a payment account that may be provided to a merchant in order to fund a financial transaction via the associated payment account. Transaction accounts may include credit cards, debit cards, charge cards, stored-value cards, prepaid cards, fleet cards, virtual payment numbers, virtual card numbers, controlled payment numbers, etc. A transaction account may be a physical card that may be provided to a merchant, or may be data representing the associated payment account (e.g., as stored in a communication device, such as a smart phone or computer). For example, in some instances, data including a payment account number may be considered a transaction account for the processing of a transaction funded by the associated payment account. In some instances, a check may be considered a transaction account where applicable.

Primary Purchase Geographic Area—A geographic area in which the consumer purchases within a reasonable distance of his residence or residences. The distance is variable depending on the circumstances, but generally means that an overnight stay to a different location, and/or travel on a long distance carrier such as an airline, bus or train to a different location may be considered as being outside the primary purchase geographic area. The primary purchase geographic area may be a designated zip code or postal code, a county, a municipality, a country of the bank that issued the payment card 104, may be defined using latitude and longitude or any other defined geographic area that defines the area in which the consumers primarily makes their purchases.

Advertising Agency—Advertising agencies, merchants, retailers, offer providers and other entities that produce and/or distribute advertisements, coupons, offers, rewards or any other mechanism that is designed to encourage a consumer to consume a product and/or service.

### System for Analyzing the Transaction Data

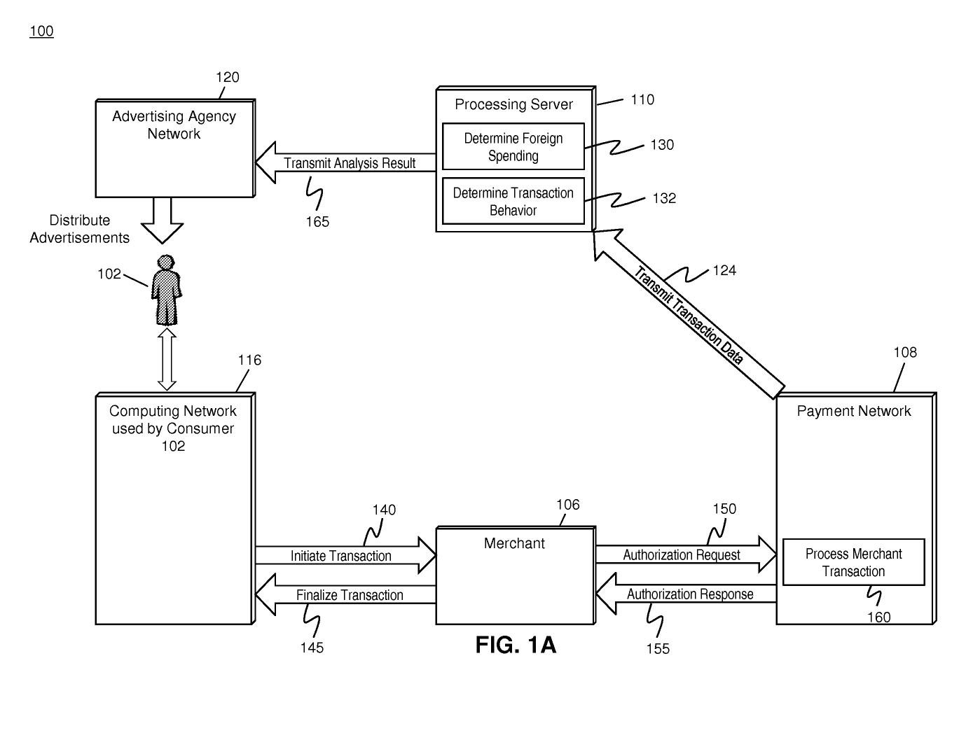

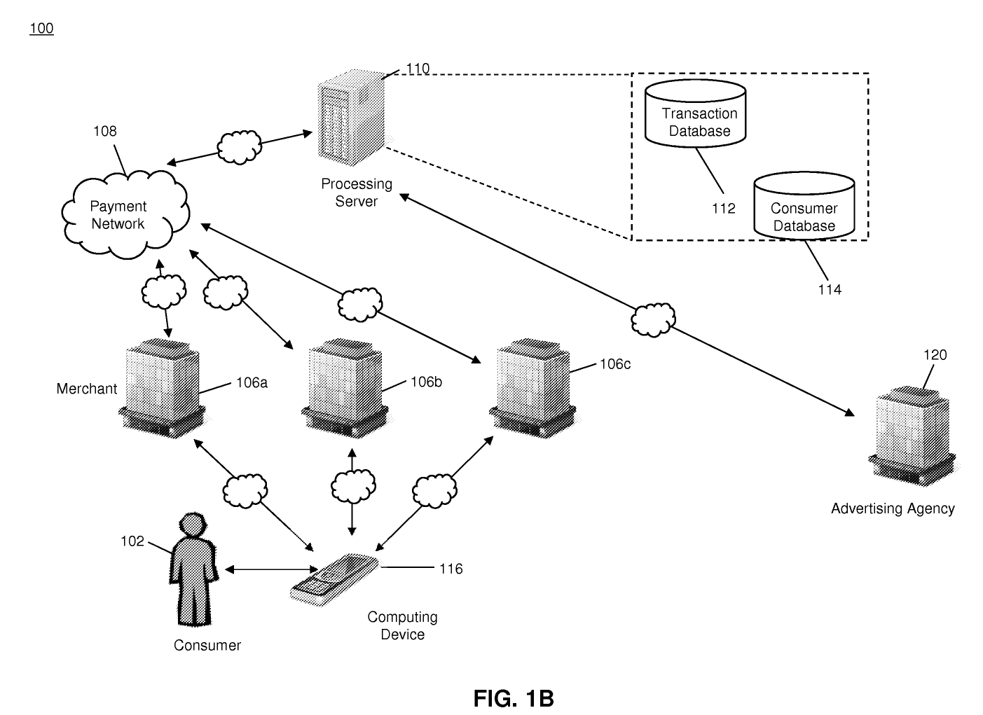

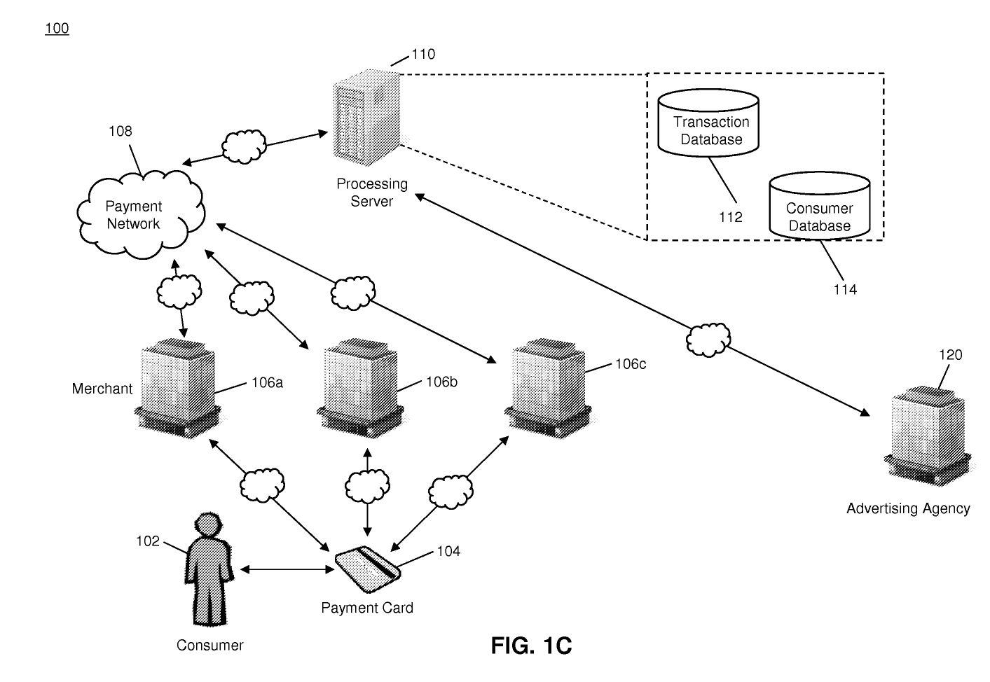

FIGS. 1A, 1B, and 1C illustrate a system 100 for the analysis of transaction data to determine travel-related spending.

The system 100 may include a computing network 116 associated with and used by a consumer 102, such as a computing device (e.g., personal computer, tablet, laptop, PDA, smartphone etc.) connected to the internet or other network etc. In some instances, the consumer's computing device may be used at a point of sale and may be a smart phone or chip bearing credit card. Traditional swipe based cards are also included. A payment card issued to the consumer 102 by an issuer (e.g., an issuing bank) is associated with a payment account of the consumer 102 and held by the issuer. The consumer 102 may engage in financial transactions with a plurality of merchants 106, such as merchants 106a, 106b, and 106c illustrated in FIGS. 1B and 1C. As part of the financial transactions, the consumer 102 may use the payment card 104 for payment.

Each of the merchants 106 may process the financial transactions using methods that will be apparent to persons having skill in the relevant art, such as by submitting authorization requests to (e.g., via an acquirer, such as an acquiring bank) a payment network 108 for processing. The payment network 108 may process the financial transaction using methods that will be apparent to persons having skill in the relevant art. After the transaction has been completed, the payment network 108 may provide transaction data for each of the financial transactions to a processing server 110. The processing server 110, discussed in more detail below, may store the transaction data in a transaction database 112, also discussed in more detail below.

As illustrated in FIG. 1B, the system 100 may include a computing network 116 associated with and used by a consumer 102, such as a computing device (e.g., personal computer, tablet, laptop, PDA, smartphone etc.) connected to the internet or other network etc. In some instances, the consumer's computing device may be used at a point of sale and may be a smart phone or chip bearing credit card. Traditional swipe based cards are also included.

The processing server 110, discussed in more detail below, may be configured to receive transaction data for a consumer 102 and analyze the transaction data. The transaction data may correspond to a plurality of payment transactions, and may be received from a payment network 108. In some embodiments, the processing server 110 may be a part of the payment network 108 and may be further configured to perform additional functions based thereon. For example, the processing server 110 may be further configured to process payment transactions as part of the payment network 108.

The processing server 110 may include a transaction database 112, discussed in more detail below. The transaction database 112 may be configured to store transaction data associated with a plurality of payment transactions. The transaction data may include, for instance, transaction times, transaction dates, transaction amounts, merchant data, product data, consumer data, geographic locations, etc. In some embodiments, the transaction data may be captured during the processing of payment transactions by the processing server 110 and/or the payment network 108.

The system 100 may also include an advertisement agency having a computing network 120. The advertisement agency having a computing network 120 may be any system and/or person that would be interested in obtaining the analysis results from the processing server 110. Additional entities that may be included in the advertisement agency having a computing network 120 will be apparent to persons having skill in the relevant art.

The processing server 110 may be configured to receive the transaction data 124 from the payment network 108. The processing server 110 may then analyze the transaction data 124 to identify payment transactions that were conducted outside of the primary purchase geographic area associated with the consumer. In some embodiments, the payment transactions analyzed may be limited to a period of time in which the advertising agency 120 is interested in.

In some embodiments, the processing server 110 may categorize the payment transactions based on transaction data. The transaction data 124 may include a plurality of purchase attributes. For example, the processing server 110 may identify consumer propensities to spend across a plurality of purchase attributes such as product categories, product names, merchant categories, merchants, industry categories, industry identifier, and/or transaction date, etc. In another example, the processing server 110 may categorize the payment transactions based on the time of the transaction. For instance, transactions directed to travel-spending may be segmented based on the seasons (e.g., fall, winter, summer, spring) or based on the work schedule (e.g., winter holidays, summer vacation, etc.)

In some instances, the processing server 110 may categorize the spending behavior based on a specific merchant or merchants. In such an instance, the processing server 110 may identify transactions involving a specific merchant or merchants, such as a particular merchant (e.g., American Airlines®) or a particular industry (e.g., airlines). The processing server 110 may then identify payment transactions directed to the particular industry.

### Processing Server

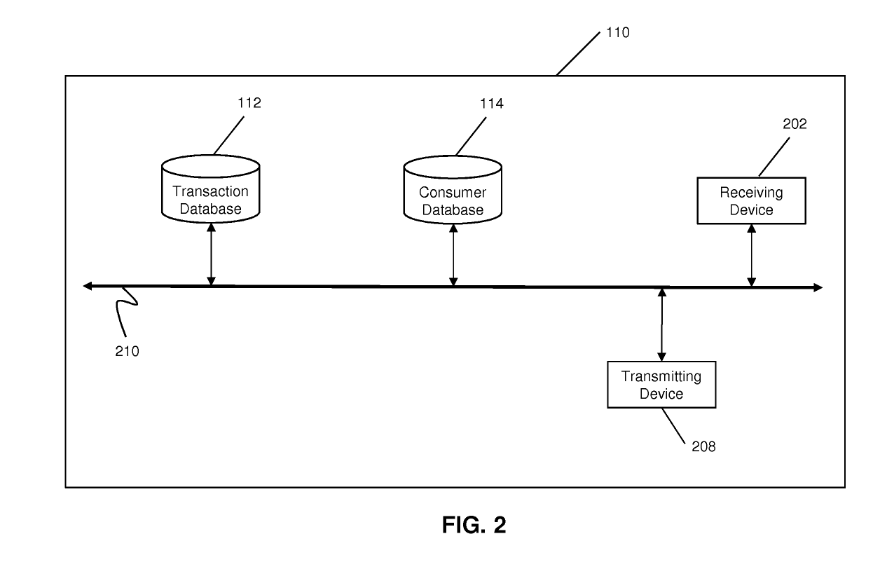

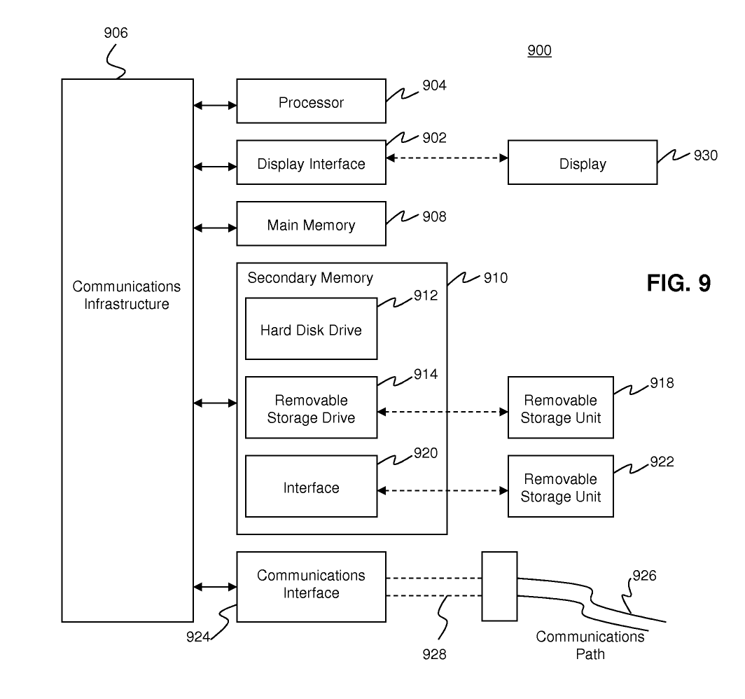

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 900 illustrated in FIG. 9 and discussed in more detail below may be a suitable configuration of the processing server 110.

The processing server 110 may include a receiving device 202. The receiving device 202 may be configured to receive data from one or more networks (e.g., the Internet) via one or more network protocols (e.g., Internet Protocol), such as transaction data transmitted to the processing server 110 by the payment network 108. The processing server 110 may be configured to store the received payment transaction information in the consumer database 114 and the transaction data in the transaction database 112.

The consumer database 114 may be configured to store a plurality of payment data entries corresponding to the transaction data for the financial transactions, received from the payment network 108. Each payment data entry may include at least a consumer identifier. The consumer identifier may be a unique value associated with a consumer (e.g., the consumer 102) used for identification, and may be included in the authorization request for the corresponding financial transaction. For example, the consumer identifier may be a payment account number associated with the payment account used to fund the financial transaction. Each payment data entry may further include a location identifier, timing information, and transaction data, discussed in more detail below.

As discussed in more detail below, the processing server 110 may be configured to analyze the transaction data 124 received in the payment transactions and generate a filtered set of payment transactions and store the filtered set of payment transactions for each consumer in the transaction database 112. The processing server 110 may be further configured to analyze the filtered set of payment transactions and categorize the consumers based on the travel-related transactions as described below.

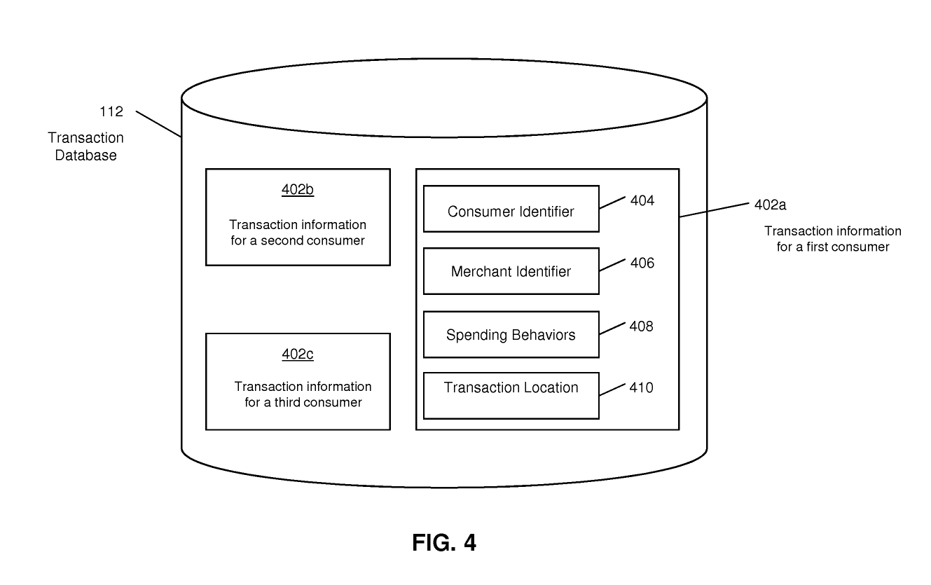

FIG. 4 illustrates an exemplary structure of the transaction database 112. The transaction database 112 may have plural entries 402a, 402b, 402c, etc. corresponding to each consumer and the associated transaction information. Each entry storing the transaction data for a given consumer 102 may include, but is not limited to, the customer identifier 404, merchant identifier 406, product identifier(s) 408, transaction type 410, time, date, amount, etc. It will be apparent to persons having skill in the relevant art that the embodiment of the transaction database 112 illustrated in FIG. 4 is provided as illustration only and may not be exhaustive to all possible configurations of the transaction database 112 suitable for performing the functions as discussed herein.

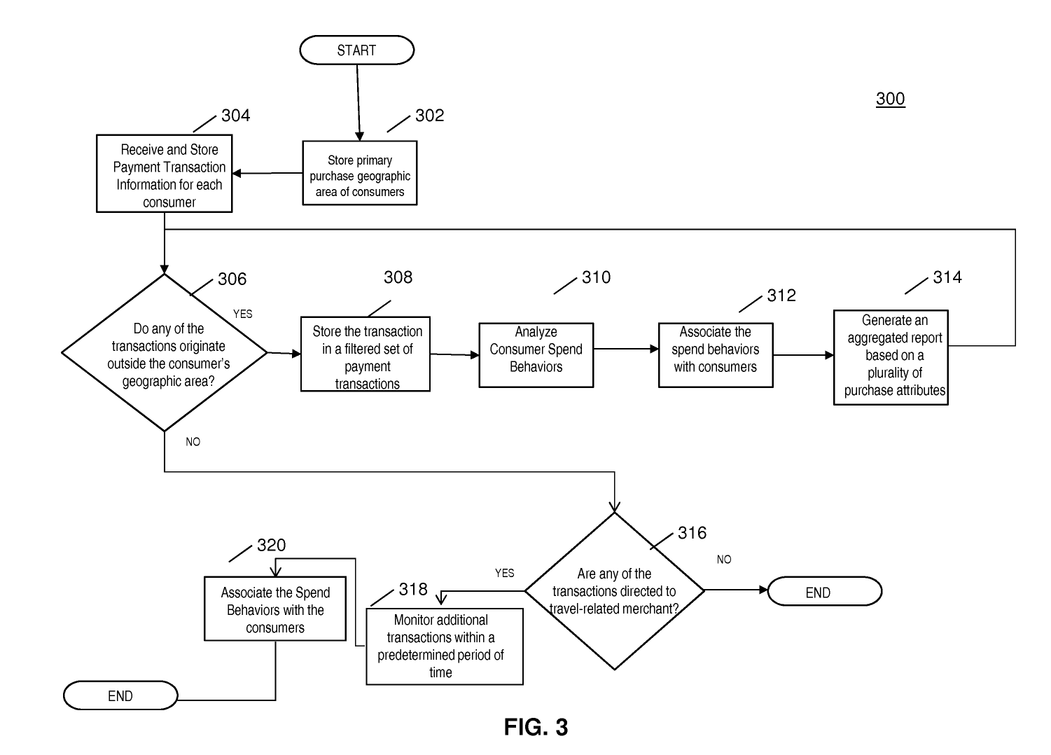

FIG. 3 illustrates a method 300 for analyzing consumer spending behaviors using the processing server 110.

At Step 302, the processing server 110 stores the primary purchase geographic area associated with the consumers in the consumer database 114.

At Step 304, the receiving device 202 receives the transaction data 124 for a plurality of transactions conducted by the consumer 102 and stores the transaction data 124 in the transaction database 112. The transaction data 124 may include a plurality of purchase attributes associated with each of the payment transactions conducted by the consumer 102. The purchase attributes may include, but are not limited to, product data, one or more product identifiers (e.g., airline tickets), one or more product names (e.g., skiing lessons), transaction time and location (e.g., date, time, geographic location), merchant identifier (e.g., travel lodge), merchant name (e.g., Mt. Killington Resort®), industry identifier, industry category (e.g., ski resort), and/or a consumer identifier (e.g., information about the user 102). A person skilled in the art would appreciate that additional purchase attributes may be included in the transaction data 124 transmitted from the payment network 108 to the processing server 110.

At Step 306, the processing server 110 determines whether any of the payment transactions were conducted at a location outside of the primary purchase geographic area associated with the consumer and stored in the processing server 110 at Step 302. If none of the payment transactions were conducted at a location outside of the primary purchase geographic area associated with the consumer, the method moves to Step 316.

If, at Step 306, it is determined that some of the payment transactions were conducted at a location outside of the primary purchase geographic area associated with the consumer, the processing server 110 analyses the stored transaction data in the transaction database 112 to filter those payment transactions. The filtered payment transactions are then stored along with the associated transaction data in the transaction database 112 and the consumer database 114 at Step 308. Next, at Step 310, the processing server 110 analyzes the filtered set of payment transactions to determine the consumer spend behaviors. In one instance, the processing server 110 may determine the frequency of the payment transactions conducted directed to travel-related spending as a relationship to the consumer's total spending.

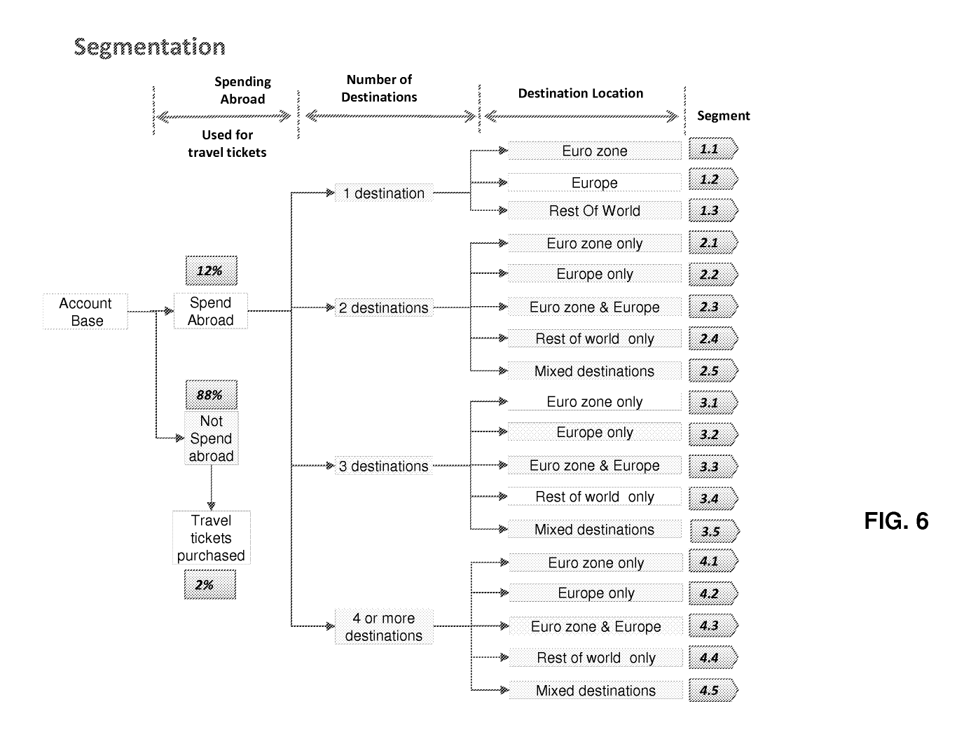

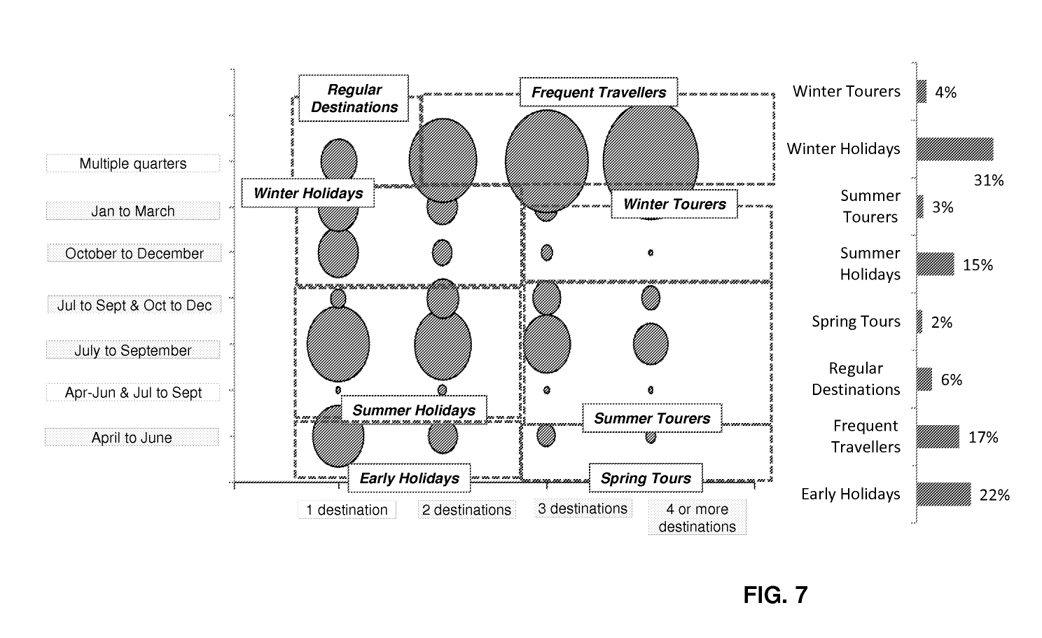

At Step 312, the processing server 110 associates the analyzed spend behaviors with the consumers. The method is repeated for a plurality of consumers. At Step 314, the processing server 110 generates an aggregated report including a particular consumer's relative placement within the set of consumers whose payment transactions were analyzed based on a plurality of purchase attributes included in the filtered set of payment transactions. FIGS. 6 and 7, described later, provide exemplary aggregated reports. The reports may be specific to an individual, whether identified or not, or aggregated to effectively make the individual consumers anonymous.

The processing server 110 may further analyze the filtered set of payment transactions and the associated transaction data 124 stored in the transaction database 112 and the consumer database 114. For instance, the processing server 110 may categorize the filtered set of payment transactions based on one of the purchase attributes. The aggregated report may be displayed on a display device. In one aspect of the system and method disclosed here, the processing server 110 may transmit the aggregated report to the advertising agency having a computing network 120. This information would be particularly useful to advertising agencies, merchants, credit card companies or the like because these consumers are likely to be traveling outside their primary purchase geographic area. Therefore, the advertising agencies, merchants, credit card companies or the like may be able to target their offers to these consumers and tailor these offers (e.g., suggesting restaurants in the location where the foreign transactions are being conducted, etc.) so that the consumers are more likely to use these offers.

If at Step 306, it is determined that none of the payment transactions were conducted at a location outside of the primary purchase geographic area associated with the consumer, the method moves to Step 316. At Step 316, the processing server 110 determines whether any of the payment transactions were directed to travel-related merchants but were not conducted outside the primary purchase geographic area associated with the consumer. By way of example, a non-exhaustive list of travel-related merchants may include airlines, cruise ship vendors, travel agencies, resorts, or the like. In one exemplary embodiment, the processing server may determine a travel-related merchant based on the product that was purchased. For instance, a consumer living in Austin, Tex., making a purchase at Black Diamond Equipment® (a ski shop) may be identified as a consumer making a “travel-related” purchase. A person skilled in the art would appreciate that travel-related merchants may be identified based on a plurality of purchase attributes and the above list only lists illustrative examples.

If at Step 316, it is determined that none of the payment transactions were directed to a travel-related merchant, the processing is terminated for the consumer. If at Step 316, it is determined that at least one of the payment transactions were directed to a travel-related merchant, the processing server 110 monitors additional payment transactions made by the consumer for a predetermined period of time at Step 318. For instance, the consumer's payment transactions may be monitored for an additional period (e.g., six months if the skis are bought during the fall season) to identify additional payment transactions conducted with travel-related merchants or additional payment transactions conducted outside their primary purchase geographic area.

At Step 320, the processing server 110 associated the spend behaviors with consumers who make travel-related purchases that were conducted within their primary purchase geographic area. In one exemplary embodiment, the processing server 110 may generate a second aggregated report including consumers conducting transactions with travel-related merchants within their primary purchase geographic area. This information would be particularly useful to advertising agencies, merchants, credit card companies or the like because these consumers are likely to be traveling outside their primary purchase geographic area. Therefore, the advertising agencies, merchants, credit card companies or the like may be able to target their offers to these consumers and tailor these offers (e.g., waiving foreign transaction fees, etc.) so that the consumers are more likely to use these offers.

FIGS. 6-8 illustrate a non-exhaustive set of examples of the information that may be generated by the processing server 110 and presented in the aggregated report.

FIG. 6 shows a chart illustrating one example of the aggregated report generated by the processing server 110. In the example shown in FIG. 6, payment transactions for a plurality of consumers are analyzed by the processing server 110. The set of consumers may be selected based on a number of factors. By way of example only, the factors may include, but not limited to, the geographic location of the consumers (e.g., analyzing payment transactions of consumers living in Austin, Tex.), the gross income of consumers (e.g., consumers who have an annual gross income higher than $65,000), the spending behavior of consumers (e.g., consumers who use a single credit card, charge card, debit card, or the like for everyday purchases; consumers who use multiple credit cards, charge cards, debit cards, or the like for everyday purchases; etc.), and/or family size of consumers (e.g., consumers who are married and/or have children).

Of the set of consumers, the aggregated report shown in FIG. 6 indicates that 12% of the consumers whose payment transactions were analyzed have conducted foreign spending (i.e., payment transactions conducted outside the primary purchase geographic area associated with the consumers). Of the 88% of the consumers whose payment transactions were analyzed and did not engage in any foreign spending, 2% of the consumers purchased travel tickets. The processing server 110 may further analyze the payment transactions of these 2% of consumers to determine additional information about them including, but not limited to, the location of their destination, and the estimated travel date. The kind of information shown in FIG. 6 would be particularly useful to credit card companies, charge card companies, debit card companies, or the like. Specifically, these companies would be interested in knowing the consumers who are buying travel tickets but are not conducting any foreign transactions on the card (the 2% represented in FIG. 6), indicating that the transactions could be being spent on another card or by using foreign currency.

The aggregated report shown in FIG. 6 may include additional information about the 12% of consumers who engaged in foreign spending. The information may include categorizing the consumers based on the number of different destinations they have visited within a given period of time. The processing server 110 may further categorize the 12% of consumers who engaged in foreign spending based on the location of the destination. For instance, in the example illustrated in FIG. 6, consumers who travel only once within the given period of time (e.g., past year) and travel to the Euro Zone are segmented into group 1.1, consumers who travel only once within the given period of time (e.g., past year) and travel to the Europe (outside of Euro Zone) are segmented into group 1.2, consumers who travel only once within the given period of time (e.g., past year) and travel to the rest of the world (outside of Europe generally) are segmented into group 1.3. Similarly, consumers who travel to multiple destinations may be segmented based on the destination locations (e.g., 2.1-2.5, 3.1-3.5, and 4.1-4.5 as shown in FIG. 6).

The above information would be particularly useful to merchants, retailers, manufacturers, entities intending to target advertisements to consumers, and offer providers, who can customize the offers generated and transmitted to the consumers based on their travel preferences and tendencies.

FIG. 7 shows a chart illustrating an example of an aggregated report which categorizes the consumers based on the time of the foreign travel. The vertical axis of the chart shown in FIG. 7 shows the various quarters into which the consumers are segmented. It will be apparent to persons skilled in the art that the scale of the vertical axis may be adjusted to represent any number of time-based segmentations including, but not limited to, months, weather seasons, school schedules etc. The horizontal axis represents the number of destinations that consumers visit. The sizes of the bubbles show the size of the particular segment (i.e., the number of consumers falling within a specific category).

For instance, the chart shown in FIG. 7 indicates that there is a relatively large subset of consumers (approximately 15%) who travel to only one destination in a given year during the summer holidays, and more specifically, within the months July to September. The chart also shows that of the people traveling more frequently (i.e., 3 or more destinations), a relatively small number of consumers (approximately 2%) prefer to travel during the spring season, and more specifically, within the months of April to June.

The above information would be particularly useful for merchants, retailers, manufacturers, entities intending to target advertisements to consumers, and offer providers, to encouraging spend within a portfolio, and focussing on promoting spend abroad or even spend in preparation for travel abroad.

For instance, a marketing department may want to know: which consumers are travelling abroad to inform who to target; when the consumers travel to ensure that timing of communications is appropriate; how frequently the consumers travel to ascertain regular travelers versus holiday tourists; which destinations the consumers prefer to go to tailor the message in case of specific promotions/offers/cross sales; and/or whether the destination is outside of the host currency (which can earn extra foreign transaction commission). The above information is determined by the processing server 110. Specifically, the transaction data includes the transaction location, the time of the transaction, and the date of the transaction. The processing server 110 analyses the transaction data to categorize the consumers based on the above purchase attributes. The results of the analysis by the processing server may be presented in the aggregated report.

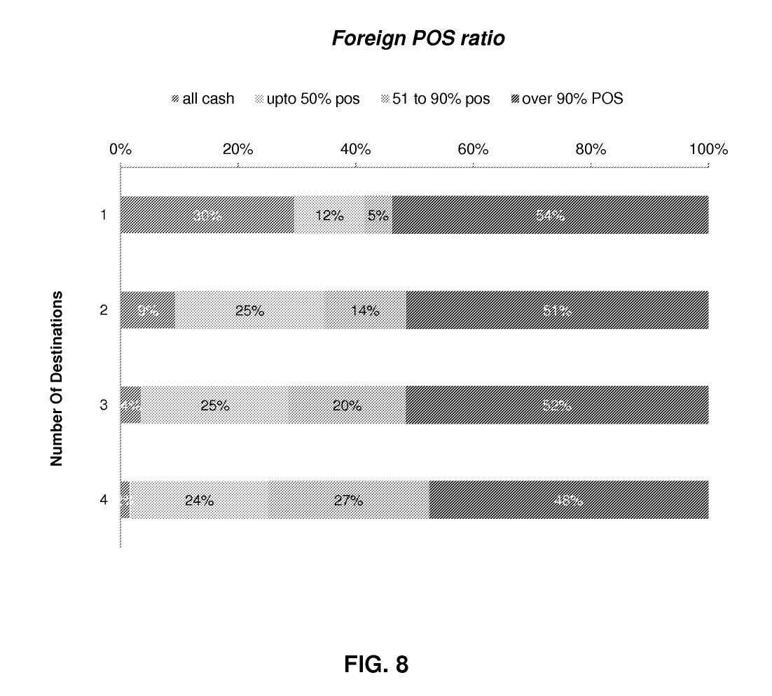

FIG. 8 shows a bar graph categorizing the consumers based on their preferred method of payments while they are traveling. FIG. 8 depicts the ratio of spending at point-of-sale systems vs. cash equivalents. The kind of information shown in FIG. 8 would be particularly useful to credit card companies, charge card companies, debit card companies, or the like. Specifically, these companies would be interested in knowing the usage patterns of the consumers and design offers to encourage spending. For instance, the credit card companies, charge card companies, debit card companies, or the like may waive or reduce foreign transaction fees for consumers spending above a particular amount (e.g., $1,000) in order to promote foreign spending using the transaction account and induce the consumers to change their preferred methods of payment from cash usage to point of sale systems.

In the example shown in FIG. 8, the vertical axis represents the number of destinations traveled to by the consumers. The horizontal axis represents the breakdown of usage between cash and point-of-sale systems used by the consumers. For instance, the graph shows that, of the consumers who travel to four or more destinations within a given year, only 2% of these consumers exclusively use cash for all their foreign purchases, 24% use point-of-sale systems for some of their foreign transactions (up to 50%), 27% of consumers use point-of-sale systems for a majority of their foreign transactions (51%-90%), and nearly half of these consumers primarily use point-of-sale systems for their foreign transactions (over 90%). Similarly, of the consumers who travel to two destinations within a given year, only 9% of these consumers exclusively use cash for all their foreign purchases, 25% use point-of-sale systems for some of their foreign transactions (up to 50%), 14% of consumers use point-of-sale systems for a majority of their foreign transactions (51%-90%), and more than half of these consumers primarily use point-of-sale systems for their foreign transactions (over 90%).

That is, the chart shows that the usage of cash as the preferred method for foreign transactions reduces sharply as the consumers visit additional destinations within a given year. As described above, the above information would be particularly helpful to merchants, retailers, manufacturers, entities intending to target advertisements to consumers, and offer providers, who can customize the offers generated and transmitted to the consumers based on their travel preferences and tendencies.

In one exemplary embodiment, the aggregated report may include the top five destinations (e.g., cities, countries) based upon the amount spent at the destination, whether the destination was in the Euro Zone, rest of Europe or rest of the world, the percentage of total foreign spending that the top five destinations encompass, spending per quarter for each destination, first and last transaction per quarter to determine spending duration, holiday seasons when spending occurs, specific spending on airlines, domestic cruise lines and domestic travel agencies to determine if tickets are being bought but foreign transactions are not appearing on a particular credit card, charge card, debit card or the like.

The method may further include transmitting the aggregated reports to the computing network 120 of the advertising agency. The advertising agency may then generate targeted offers which cater to the specific preferences of the consumers and transmit these offers in a timely manner to the consumers. The computing network 120 of the advertising agency may monitor future transactions of the consumers who receive these offers to determine the success rate of the consumers. In one embodiment, the computing network 120 of the advertising agency may request feedback after delivering a product purchased by the consumer using a targeted offer.

### Computer System Architecture

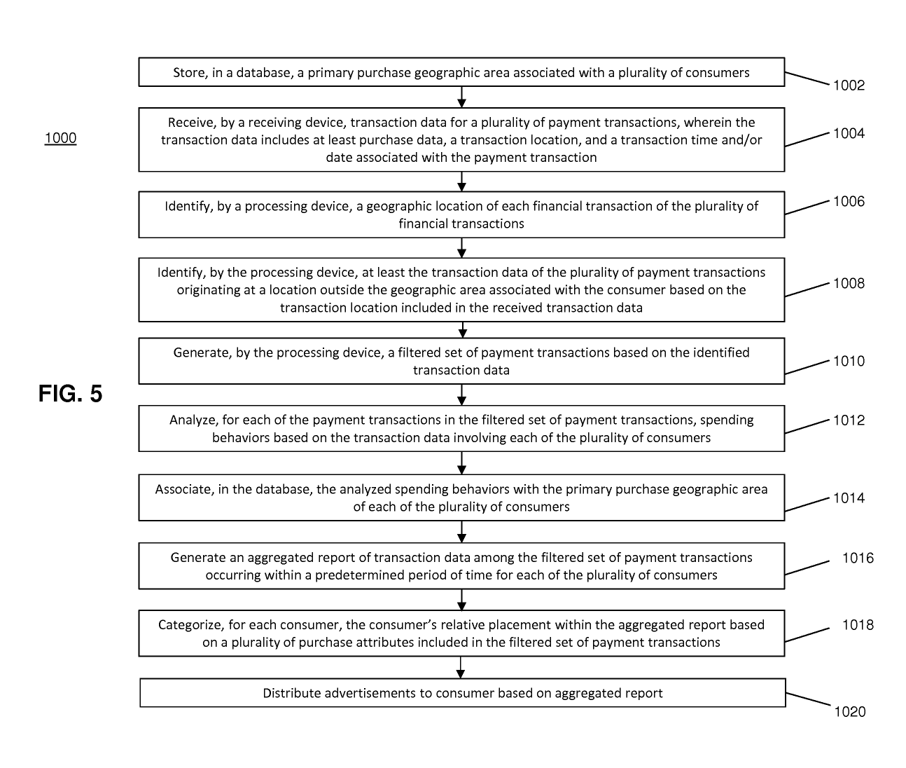

FIG. 9 illustrates a computer system 900 in which embodiments of the present disclosure, or portions thereof, may be implemented as computer-readable code. For example, the processing server 110 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 718 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g. DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3 and 5, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for analyzing spending data for foreign spending. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying purchase transaction data for promoting foreign spending, comprising:
storing, in a database, a geographic area associated with a primary purchase area of each of a plurality of consumers;
receiving, by a receiving device, transaction data for a plurality of payment transactions for each of the plurality of consumers, wherein the transaction data includes at least purchase data, a transaction location, and a transaction time and/or date associated with the payment transaction;
identifying, by a processing device, at least the transaction data of the plurality of payment transactions originating at a location outside the primary purchase geographic area associated with the consumer based on the transaction location included in the received transaction data;
generating, by the processing device, a filtered set of payment transactions based on the identified transaction data;
analyzing, for each of the payment transactions in the filtered set of payment transactions, spending behaviors based on the transaction data involving the plurality of consumers;
associating, in the database, the analyzed spending behaviors with the primary purchase geographic area associated with each of the plurality of consumers;
generating, by the processing device, an aggregated report of transaction data among the filtered set of payment transactions occurring within a predetermined period of time for the plurality of consumers; and
categorizing, for each of the plurality of consumers, the consumer's relative placement within the aggregated report based on a plurality of purchase attributes included in the filtered set of payment transactions.

2. The method of claim 1, wherein the transaction data includes a merchant type, the method further comprising:
identifying, from the filtered set of payment transactions, consumers having a single payment transaction originating at a location outside the primary purchase geographic area associated with the consumer within the predetermined period of time, the single payment transaction being directed to a travel-related merchant type.

3. The method of claim 1, wherein the purchase attributes include at least one of: a payment account number, a merchant identifier, a merchant type, a consumer identifier, an internet protocol address, product data, one or more product identifiers, one or more product names, an industry identifier, and an industry category.

4. The method of claim 1, wherein the geographic area is based on a zip code or a postal code.

5. The method of claim 1, wherein the geographic area is defined by latitude and longitude measurements.

6. The method of claim 1, wherein the geographic area is based on municipal boundaries.

7. The method of claim 1, wherein identifying the location of each financial transaction includes identifying, in a database, the latitude and longitude of a merchant included in the financial transaction.

8. The method of claim 1, wherein analyzing each of the payment transactions in the filtered set of payment transactions includes determining a frequency of payment transactions originating at a specific location outside the geographic area associated with the consumer within the predetermined period of time.

9. The method of claim 1, further comprising:
determining a frequency of travel-related transactions originating at a location outside the geographic area associated with the consumer within the predetermined period of time.

10. The method of claim 1, further comprising:
directing targeted communication to the consumer based on the aggregated report.

11. A system for identifying purchase transaction data for promoting foreign spending, comprising:
a database storing a geographic area associated with a primary purchase area of each of a plurality of consumers;
a receiving device configured to receive transaction data for a plurality of payment transactions for each of the plurality of consumers, wherein the transaction data includes at least purchase data, a transaction location, and a transaction time and/or date associated with the payment transaction;
a processing device configured to
identify at least the transaction data of the plurality of payment transactions originating at a location outside the primary purchase geographic area associated with the consumer based on the transaction location included in the received transaction data;
generate a filtered set of payment transactions based on the identified transaction data;
analyze, for each of the payment transactions in the filtered set of payment transactions, spending behaviors based on the transaction data involving the plurality of consumers;
associate, in the database, the analyzed spending behaviors with the primary purchase geographic area associated with each of the plurality of consumers;
generate an aggregated report of transaction data among the filtered set of payment transactions occurring within a predetermined period of time for the plurality of consumers; and
categorize, for each consumer, the consumer's relative placement within the aggregated report based on a plurality of purchase attributes included in the filtered set of payment transactions.

12. The system of claim 11, wherein the transaction data includes a merchant type, the system further comprising:
identifying, from the filtered set of payment transactions, consumers having a single payment transaction originating at a location outside the primary purchase geographic area associated with the consumer within a predetermined period of time, the single payment transaction being directed to a travel-related merchant type.

13. The system of claim 11, wherein the purchase attributes include at least one of: a payment account number, a merchant identifier, a merchant type, a consumer identifier, an internet protocol address, product data, one or more product identifiers, one or more product names, an industry identifier, and an industry category.

14. The system of claim 11, wherein analyzing each of the payment transactions in the filtered set of payment transactions includes determining a frequency of payment transactions originating at a specific location outside the geographic area associated with the consumer within the predetermined period of time.

15. The system of claim 11, wherein the geographic area is based on a zip code or a postal code.

16. The system of claim 11, wherein the geographic area is defined by latitude and longitude measurements.

17. The system of claim 11, wherein the geographic area is based on municipal boundaries.

18. The system of claim 11, wherein identifying the location of each financial transaction includes identifying, in a database, the latitude and longitude of a merchant included in the financial transaction.

19. The system of claim 11, wherein the processor is further configured to determine a frequency of travel-related transactions originating at a location outside the geographic area associated with the consumer within the predetermined period of time.

20. The system of claim 11, wherein the processor is further configured to direct targeted communication to the consumer based on the aggregated report.
